(19) United States
(12) Patent Application Publication
(10) Pub. No.: US 2023/0025730 A1
(43) Pub. Date: Jan. 26, 2023

(54) UNIQUE SYSTEM FOR TRAVEL PLANNING WITH CONSOLIDATED FEATURES OF NAVIGATION AND PLANNING

(71) Applicants: SALAH M. WERFELLI, MORGAN HILL, CA (US); SAM L. APPLETON, MORGAN HILL, CA (US); KHALED JASSIM J S AL-JABER, DOHA (QA); TANWIR ZAFAR SYEDMOHAMMAD, TRACY, CA (US)

(72) Inventors: SALAH M. WERFELLI, MORGAN HILL, CA (US); SAM L. APPLETON, MORGAN HILL, CA (US); KHALED JASSIM J S AL-JABER, DOHA (QA); TANWIR ZAFAR SYEDMOHAMMAD, TRACY, CA (US)

(21) Appl. No.: 17/382,209

(22) Filed: Jul. 21, 2021

(51) Int. Cl. G06Q 50/14; G06Q 50/00; G06Q 10/02; G01C 21/34; G01C 21/36; G06F 3/0481; G06F 3/16; G10L 15/22

(52) U.S. Cl. CPC G06Q 50/14; G06Q 50/01; G06Q 10/02; G01C 21/343; G01C 21/3691; G06F 3/04817; G06F 3/167; G10L 15/22; G10L 2015/223

(57) ABSTRACT

The present invention discloses a unique system for travel contemplation. The present invention particularly discloses a travel contemplating system with consolidating features of planning and navigating for site visits and accommodation at the same time simultaneously. In addition, the aforementioned system also provides integrated facilities of accessing all sorts of multimedia for entertainment while travelling.

### CROSS REFERENCE OF RELATED PATENT(S) OR APPLICATION(S)

The current application claims benefit of U.S. Provisional Patent Application 63/054,408 filed Jul. 21, 2020.

### FIELD OF THE INVENTION

The present invention related to a unique system for travel contemplation. The present invention particularly relates to a travel contemplating system with consolidating features of planning and navigating for site visits and accommodation at the same time simultaneously. In addition, the aforementioned system also provides integrated facilities of accessing all sorts of multimedia for entertainment while travelling.

### BACKGROUND OF THE INVENTION

A travel agency is a private retailer or public service that may provide tourism related services to the public on behalf of suppliers, such as airlines, car rentals, cruise lines, hotels, railways, and package tours. Travelers frequently make travel arrangements using travel agencies. Some travel agencies have a presence on the internet and provide software that enables travelers to make travel arrangements on the World Wide Web. Such software may provide a traveler with available flights, hotels, rental cars and activities from which a traveler may make a selection. Such software may enable the traveler to input a date and time of a desired flight, and a flight starting point and destination.

There are various types of navigation apps and trip planning apps available in the market, but there isn't any that provides both features under one app. Also, navigation apps and trip planning apps are not connected to users and doesn't show contacts nearby.

### SUMMARY OF THE INVENTION

Accordingly, one aspect of the present invention discloses a unique system for travel planning with consolidated features of navigation and planning wherein the aforesaid system comprises:
(a) a map for showing any contact in the vicinity and browse location based on their categories;
(b) an icon for clicking on any location to open its full profile that includes users details along with the information of the desired location;
(c) a voice command to capture the audio instructions by the user;
(d) provision of finding and adding contacts to users account, create number of of categories of users contacts along with option of accepting and rejecting contact request;
(e) provision of planning user's trip along with the provision of start and end date of the trip, accommodation location, places and attractions, featured location and other information about the featured location;
(f) real-time navigation of the location and manage events;

In another aspect of the present invention, the user of the aforesaid system can communicate in any language of his preference.

In another aspect of the present invention, the user can share the multimedia are selected from the group consisting of image, video, gifs, audio, files, text, document etc.

In another aspect of the present invention, user of the aforesaid system can create as many groups of their choice and can assign users of the each group.

In another aspect of the present invention, user can access important information of the desired location along with current weather conditions and forecast, public reviews, photos, videos, latest local news and other information.

In another aspect of the present invention, important information of the desired location displays hotels information, places and attractions, featured location and other information about the city.

In another aspect of the present invention, the aforesaid system provides detailed profile of locations, and also schedule their trips to those cities.

In another aspect of the present invention, the aforesaid system provides user directions to any place and then real-time navigation will help him reach that location.

In another aspect of the present invention, the aforesaid system provides the users a facility to book hotels and accommodations right from within the the aforesaid system and also listen to their favorite music on the go.

In another aspect of the present invention, user can add as many cities and places as he wants in his wish lists and can access real-time information about latest events and happenings in those cities and locations and helps them visit and enjoy those events by creating a trip for them.

In another aspect of the present invention, the aforesaid system provides information regarding nearby attractions and people based on his interests, his visits history, his preferences and his work.

In another aspect of the present invention, the aforesaid system provides information regarding the shortest path to save him from congestions and traffic jams.

### DETAILED DESCRIPTION OF THE INVENTION

The present invention may be understood more readily by reference to the following detailed description of the invention taken in connection with the accompanying drawing figures, which forms a part of this disclosure. It is to be understood that this invention is not limited to the specific devices, methods, conditions or parameters described and/or shown herein and that the terminology used herein is for the example only and is not intended to be limiting of the claimed invention. Also, as used in the specification including the appended claims, the singular forms ‘a’, ‘an’, and ‘the’ include the plural, and references to a particular numerical value includes at least that particular value unless the content clearly directs otherwise. Ranges may be expressed herein as from ‘about’ or ‘approximately’ another particular value. when such a range is expressed another embodiment. Also, it will be understood that unless otherwise indicated, dimensions and material characteristics stated herein are by way of example rather than limitation, and are for better understanding of sample embodiment of suitable utility, and variations outside of the stated values may also be within the scope of the invention depending upon the particular application.

Embodiments will now be described in detail with reference to the accompanying drawings. To avoid unnecessarily obscuring the present disclosure, well-known features may not be described or substantially the same elements may not be redundantly described, for example. This is for ease of understanding.

While there are flight, hotel, rental car and activity booking systems and methods currently available, recognized herein are various limitations with such systems and methods. For example, travel software presently available may not permit a traveler to book a flight, hotel or activities that coincides with the traveler's travel schedule and meet their personal preferences without any involvement from the traveler. Current systems may not proactively detect the need to book travel in order to offer booking options automatically without the traveler initiating the booking. Moreover, current systems may not categorize traveler sentiment towards different hotel, flight and rental car attributes in order to optimize booking matching to traveler preferences and offering them the inventory that may best fit their personal preferences.

This disclosure provides systems and methods for automating travel and accommodation booking, including searching for and booking flights, hotels, rental cars other transportations needs and activities. Systems provided herein can lean from and adapt to a traveler's preferences, and automatically shop for and book a flight, hotel, rental cars and activities for travelers, in some cases without any traveler involvement.

An aspect of the present disclosure provides a computer-implemented method for making travel arrangements for a user, the method comprising (a) determining a travel schedule of the user; (b) using a computer processor, conducting a search directed to travel options that coincide with the travel schedule, and storing available travel options in memory; (c) selecting one or more travel options from the available travel options; and (d) notifying the user of the one or more travel options selected in (c). In an embodiment, the method further comprises directing an electronic communication to the user to notify the user of the one or more travel options selected in (c). In another embodiment, the electronic communication is an electronic mail. In another embodiment, the one or more travel options are selected based upon a comparison of the available travel options to travel preferences of the user in memory operatively coupled to the computer processor. In another embodiment, the available travel options are weighted by any two attributes selected from star rating, user review, price and distance. In another embodiment, in (a), the travel schedule is determined by: accessing an electronic mail account of the user, which electronic mail account comprises one or more electronic mails; reviewing the one or more electronic mails to identify content that is indicative of the travel schedule; and determining the travel schedule from the identified content. In another embodiment, the content is text and/or graphical information. In another embodiment, in (a), the travel schedule is determined by accessing an electronic calendar of the user and identifying text that is indicative of the travel schedule. In another embodiment, the text comprises a date and destination location. In another embodiment, determining the travel schedule of the user comprises: receiving an invitation to a meeting from the user, wherein the invitation coincides with a travel schedule of the user; accepting the meeting invitation; and determining the travel schedule from the meeting invitation. In another embodiment, the one or more travel options are selected from the available travel options without any involvement from the user.

Another aspect of the present disclosure provides a computer-implemented method for making travel arrangements for a user, the method comprising (a) determining a travel schedule of the user; (b) using a computer processor, conducting a search directed to travel options that coincide with the travel schedule, and storing available travel options in memory; (c) presenting one or more travel options from the available travel options to the user; and (d) receiving the selection of a given travel option from the one or more travel options from the user. In an embodiment, the available travel options are weighted by any two attributes selected from star rating, user review, price and distance. In another embodiment, in (a), the travel schedule is determined by: accessing an electronic mail account of the user, which electronic mail account comprises one or more electronic mails; reviewing the one or more electronic mails to identify content that is indicative of the travel schedule; and determining the travel schedule from the identified content. In another embodiment, the content is text and/or graphical information. In another embodiment, in (a), the travel schedule is determined by accessing an electronic calendar of the user and identifying text that is indicative of the travel schedule. In another embodiment, the text comprises a date and destination location. In another embodiment, determining the travel schedule of the user comprises: receiving an invitation to a meeting from the user, wherein the invitation coincides with a travel schedule of the user; accepting the meeting invitation; and determining the travel schedule from the meeting invitation. In another embodiment, the one or more travel options are selected from the available travel options without any involvement from the user. In another embodiment, in (c) the one or more travel options are presented on a user interface (UI) of an electronic device of the user, which UI presents a given travel option and at least two attributes of the travel option selected from star rating, user review, price and distance.

Another aspect of the present disclosure provides a method for prioritizing travel options, the method comprising (a) receiving a request from a user for a travel option, wherein the request comprises a geographic location selected by the user; (b) using a computer processor, searching a database of travel options for one or more travel options that match the request of (a), which match is based on a comparison between (i) one or more travel option preferences of the user as maintained in a profile of the user, and (ii) a score of a given travel option in the database that is weighted by any two attributes selected from star rating, user review, price and distance from the geographic location; and (c) based on the search of (b), providing one or more travel options that match the request. In an embodiment, the method further comprises receiving a request form a user to book a given travel option among the one or more travel options. In another embodiment, the method further comprises booking the given travel option without any additional involvement from the user. In another embodiment, the method further comprises selecting travel option amenities and service elements that match the one or more travel option preferences. In another embodiment, the one or more travel option preferences comprise user review sentiments. In another embodiment, the match employs the use of a machine learning algorithm that takes user feedback and preferences into account and adapts the matching process based on the preferences. In another embodiment, the travel option is a hotel or flight.

Another aspect of the present disclosure provides machine executable code that, upon execution by a computer processor, implements any of the methods above or elsewhere herein.

Another aspect of the present disclosure provides a system comprising a computer processor and a memory location comprising machine executable code that, upon execution by the computer processor, implements any of the methods above or elsewhere herein.

Another aspect of the present disclosure provides a system for making travel arrangements for a user. The system comprises (a) a database of available travel options; (b) a computer processor that is programmed to (i) conduct a search of the database directed to travel options that coincide with a travel schedule of the user, (ii) weigh available travel options by any two travel option attributes selected from star rating, user review, price and distance, and (iii) store weighted available travel options in memory; and (c) an output that provides available travel options to the user. In an embodiment, the computer processor is programmed to determine the travel schedule. In another embodiment, the output is an electronic display on an electronic device of the user. In another embodiment, the computer processor is programmed to compare the available travel options to travel preferences of the user.

An aspect of the invention provides a method for making travel arrangements for a traveler. The method comprises determining a travel schedule of the traveler, and conducting, with the aid of a processor, a search directed to travel options that coincide with the travel schedule. The available travel options are then stored in one or more memory locations. One or more travel options are then selected from the available travel options. The one or more travel options are selected without any involvement from the traveler. This can be achieved based on a deep knowledge of the traveler's preferences which were previously collected and stored. The traveler is then notified of the one or more travel options selected for the traveler.

In another embodiment, the system conducts a search for available travel options that coincide with the travel plan and the traveler's preferences. The available travel options can include one or more available travel options, such as, for example, multiple flights. Each of the one or more available travel options can at least partially coincide with the travel plan of the traveler. The one or more available travel options can be stored in one or more memory locations of the system. The one or more memory locations can be coupled to the processor of the system.

In another embodiment, the system automatically selects one or more available travel options from the travel options revealed in the search. The system can either automatically book each travel option for the traveler or let the traveler complete a one-step (1 step) booking. In one-step booking, the system can book any one, two or all three of a flight, hotel and car for the traveler in a single step. For example, the system can book a hotel for the traveler. The system can automatically select various travel options for the traveler, including flight options, hotel options, ground transportation options, and food and/or drink options. In some cases, the system can select a travel option for the traveler by directing a notification to a provider of the option (e.g., hotel, airline) that the travel option is to be booked or otherwise reserved for the traveler.

In another embodiment, the system notifies the traveler of the one or more travel options selected by the system for the traveler. The system can either display the results on the screen or direct an electronic communication to the traveler, such as an electronic mail (“email”), instant message, text message, or push notification on an electronic device of the traveler.

The system can charge the traveler for the transaction including the selection of the one or more travel options. The system can request that the traveler provide payment for the transaction, such as providing electronic funds. As an alternative, the system may not request that the traveler provide payment, but the system can charge the traveler automatically.

The system can determine a travel plan of the traveler by receiving a travel itinerary from the travel. As an alternative, the system can access a calendar of the traveler to retrieve details on the travel plan of the traveler or automatically update the calendar with travel booking details. The traveler can provide the system access to the calendar of the traveler by directing the system a meeting invitation.

Systems of the present disclosure can be programmed or otherwise configured for proactive travel booking. In some situations, the system detects a traveler's need to travel in a number of ways and automatically offers the traveler booking options. This can be done either directly by the system or through other third parties or third party software (e.g., calendar, email, virtual assistant application and to-do lists), such as partners of the system. In some examples, the traveler provides the system access rights to the traveler's calendar (e.g., Outlook® calendar or Google® calendar), which enables the system to view the calendar of the traveler. The system accesses the calendar of the traveler and detects upcoming meetings (dates, times and locations), which may be in other cities. The system then determines that the traveler may need to travel from the present location of the traveler to the destination of a given meeting. The system then makes traveler arrangements for the traveler, in some cases without any involvement from the traveler. However, the system may request that the traveler authorize the traveler to make a given arrangement. Such authorization may be provided through an electronic message (e.g., email or text message).

In another embodiment, the traveler gives the system access to the traveler's email and the system detects text in the email of the traveler that that indicates that the traveler is planning on traveling. The email may include text that is indicative of a date, time, departure location and destination location of the traveler. The email can be, for example, a flight booking confirmation. In such a case, the system can offer the traveler a hotel and rental car, as well as other travel and booking options.

In other cases, travel booking can be triggered within a virtual assistant application (app) based on that app detecting the user's plan to travel. This detection can be done, for example, based on information in the user's calendar, email or to do list. Once this plan to travel is detected, personalized travel options can be offered to the user within the app or through a link or email to a UI, such as a web-based interface (e.g., as may be provided through a web site).

The system can collect hotel attributes in a number of ways. The system can collect inventory information about hotels from an online travel agency (OTA) or multiple OTA's, from the hotel website or from other sources. Attributes that the system can collect about inventory include: price band (i.e., whether the hotel typically fall into a specific price band, such as, e.g., expensive or cheap), the star rating of the hotel, customer reviews (e.g., Yelp® reviews, Hotel.com® reviews), amenities, hotel chain, type(s) of room (e.g., smoking or non-smoking), bed sizes, type of hotel (e.g., business, vacation, family), whether hotel price fluctuates throughout the year, whether there are preferable days and times to book the hotel, points of interest in proximity to the hotel, whether the hotel is at a location that may be considered of interest to travelers (e.g., hotel is in the center of town).

As an alternative, the system can collect indirect information and inferred information about the hotel. Indirect information can include travelers who post information on either review sites, hotel information on network web sites (e.g., Facebook®, Twitter®, Google+®), current information about hotel amenities. The system can monitor activity on a social media web site for information that may be relevant to the hotel. Inferred information can include grouping hotels into clusters based on their attributes, and using cluster analysis to infer an attribute of a given hotel based on attributes of the cluster. This can preclude the need to collected detailed information about every hotel in the cluster. Cluster analysis can show which attributes show up most often and which preference combinations are most common. In some cases, the system identifies the common preference groups and determines if it makes sense to tag a given group as a distinct group. The system can then assign a hotel to the group.

The system can collect hotel inventory information by continuous discovery and learning. The system can continuously update the database of the system with hotel information by periodically sampling OTA data or other sources of data and detecting a change with respect to information available in the database. In some cases, the system updates indirect information from social media providers or other network providers to identify information that is otherwise not available. Once the system collects this information, the system can perform an analysis on attributes, which may enable the system to filter attributes to optimize the hotel recommendation process.

The system can collect and understand a traveler's preferences, such as the traveler's hotel preferences, travel preferences, food and/or beverage preferences, and other preferences of or related to travel, including staying at a given location for a finite period of time, such as car rentals, activities, restaurants and ground transportation. The system can collect information by direction collection, indirect collection and inferred collection. The system can verify information and conduct sensitivity analysis, and perform continuous discovery and learning as to traveler information, including traveler preferences.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

What is claimed is:

1. A unique system for travel planning with consolidated features of navigation and planning wherein the aforesaid system comprises:
(a) a map for showing any contact in the vicinity and browse location based on their categories;
(b) an icon for clicking on any location to open its full profile that includes users details along with the information of the desired location;
(c) a voice command to capture the audio instructions by the user;
(d) provision of finding and adding contacts to users account, create number of of categories of users contacts along with option of accepting and rejecting contact request;
(e) provision of planning user's trip along with the provision of start and end date of the trip, accommodation location, places and attractions, featured location and other information about the featured location;
(f) real-time navigation of the location and manage events;

2. The system as claimed in claim 1 wherein, the user of the aforesaid system can communicate in any language of his preference.

4. The system as claimed in claim 1 wherein, the user can share the multimedia are selected from the group consisting of image, video, gifs, audio, files, text, document etc.

5. The system as claimed in claim 1 wherein, user of the aforesaid system can create as many groups of their choice and can assign users of the each group.

6. The system as claimed in claim 1 wherein, user can access important information of the desired location along with current weather conditions and forecast, public reviews, photos, videos, latest local news and other information.

7. The system as claimed in claim 1 wherein, important information of the desired location displays hotels information, places and attractions, featured location and other information about the city.

8. The system as claimed in claim 1 wherein, the aforesaid system provides detailed profile of locations, and also schedule their trips to those cities.

9. The system as claimed in claim 1 wherein, the aforesaid system provides user directions to any place and then real-time navigation will help him reach that location.

10. The system as claimed in claim 1 wherein, the aforesaid system provides the users a facility to book hotels and accommodations right from within the the aforesaid system and also listen to their favorite music on the go.

11. The system as claimed in claim 1 wherein, user can add as many cities and places as he wants in his wish lists and can access real-time information about latest events and happenings in those cities and locations and helps them visit and enjoy those events by creating a trip for them.

12. The system as claimed in claim 1 wherein, the aforesaid system provides information regarding nearby attractions and people based on his interests, his visits history, his preferences and his work.

13. The system as claimed in claim 1 wherein, the aforesaid system provides information regarding the shortest path to save him from congestions and traffic jams
